(19) United States
(12) Patent Application Publication
(10) Pub. No.: US 2025/0377737 A1
(43) Pub. Date: Dec. 11, 2025

(54) Object Sensing Using Display-Screen Illumination

(71) Applicants: Samsung Electronics Co., Ltd., Suwon-si (KR); Massachusetts Institute of Technology, Cambridge, MA (US)

(72) Inventors: Viswam Nathan, Clovis, CA (US); Zhijian Yang, Nutley, NJ (US); Boyu Zhang, Cambridge, MA (US); Szymon Fedor, Lexington, MA (US); Robert Stickgold, Cambridge, MA (US); Nathan Whitmore, Cambridge, MA (US)

(21) Appl. No.: 19/234,058

(22) Filed: Jun. 10, 2025

Related U.S. Application Data
(60) Provisional application No. 63/658,813, filed on Jun. 11, 2024.

(51) Int. Cl. G06F 3/03; G06F 1/16; G06F 3/01

(52) U.S. Cl. CPC G06F 3/0304; G06F 1/163; G06F 3/017

(57) ABSTRACT

In one embodiment, a method includes emitting light by a display screen of an electronic device; detecting, by an ambient light sensor, light received by the ambient light sensor while the display screen is emitting light; and determining, based on the emitted light and on the light detected by the ambient light sensor, whether an object is present in the vicinity of the display screen.

### PRIORITY CLAIM

This application claims the benefit under 35 U.S.C. § 119 of U.S. Provisional Patent Application No. 63/658,813 filed Jun. 11, 2024, which is incorporated by reference herein.

### TECHNICAL FIELD

This application generally relates to object sensing using display-screen illumination.

### BACKGROUND

Electronic devices often include a display screen for electronically displaying content. Many different types of display-screen technologies exist, such as LCD displays, LED displays, OLED displays, etc. A display screen emits light in order to illuminate content displayed on the screen, ensuring that a user can view the content on the display.

The brightness of a display screen is often adjustable, such as automatically by the electronic device, by a user, or both. Brightness is often measured in units of nits. Some electronic devices include an ambient light sensor that can be used to automatically adjust the brightness of a display screen. For example, an ambient light sensor may sense the brightness of the ambient light in the vicinity of the display screen, and then adjust the brightness of the display screen accordingly, e.g., by increasing display-screen brightness under relatively brighter ambient light conditions and decreasing display-screen brightness under relatively dimmer ambient light conditions.

### BRIEF DESCRIPTION OF THE DRAWINGS

FIG. 1 illustrates an example method for sensing objects in the vicinity of a display screen based on light emitted by the display screen.

FIG. 2 illustrates example patterns of light emitted by an example display screen.

FIG. 3 illustrates an example of the phase delay between detected Mi signals in a particular embodiment.

FIG. 4 illustrates an example of gesture detection using a specific illumination pattern.

FIG. 5 illustrates additional examples of gesture detection using the specific illumination pattern of FIG. 4.

FIG. 6 illustrates an example in which the slope of each amplitude signal is used to identify specific types of gestures.

FIG. 7 illustrates an example computing system.

### DESCRIPTION OF EXAMPLE EMBODIMENTS

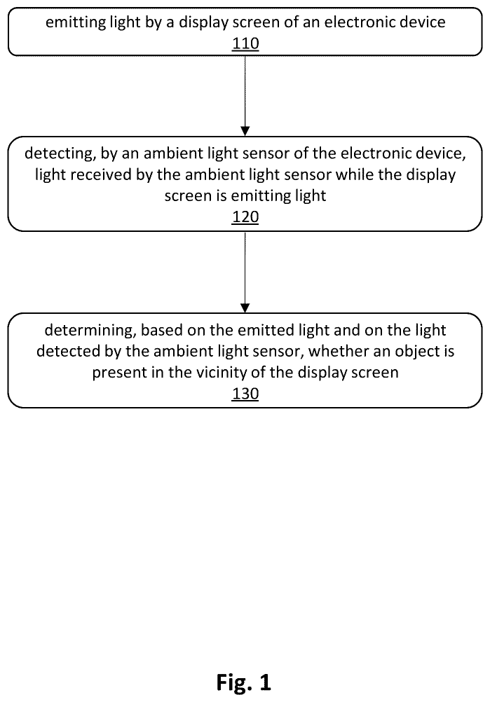

FIG. 1 illustrates an example method for sensing objects in the vicinity of a display screen based on light emitted by the display screen. Step 110 of the example method of FIG. 1 includes emitting light by a display screen of an electronic device. For instance, an electronic device may be a body-worn device, such as a chest band, necklace, wrist-worn device, etc. For example, the electronic device may be a smartwatch that has a display screen. Other examples of electronic devices include a television, phone, tablet, computer, appliance with a display screen, etc.

An electronic device can adjust the amount of light emitted by its display screen by adjusting the brightness of the display screen, i.e., a relatively higher brightness setting for a given display screen results in relatively more light emitted by the display screen compared to a relatively lower brightness setting.

Step 120 of the example method of FIG. 1 includes detecting, by an ambient light sensor, light received by the ambient light sensor while the display screen is emitting light. Here, the ambient light sensor may be one or more ambient light sensors. The ambient light sensor may be approximately coplanar with the display screen. For example, an ambient light sensor may be embedded on or in a bezel or housing that surrounds a display screen, or may be embedded on or in a display screen itself (e.g., in the middle of the display screen). In general, an ambient light sensor may be located in any suitable portion of an electronic device, provided that the ambient light sensor can detect at least some light emitted by the display screen that is reflected by an object in the vicinity of the display screen, as described below. In particular embodiments, an ambient light sensor of an electronic device may not be physically integrated with the electronic device (e.g., may be a separate device or part of a separate device that is generally co-located with the electronic device and can detect light emitted by the display screen that is reflected by an object in the vicinity of the display screen).

Step 130 of the example method of FIG. 1 includes determining, based on the emitted light and on the light detected by the ambient light sensor, whether an object is present in the vicinity of the display screen. When the display screen is emitting light and there is no object in front of the display screen, the ambient light sensor reading changes by a (typically small) value D(X) due to the light leakage from the screen to the sensor, where X represents the particular light pattern (both brightness and spatial pattern) emitted by the display screen. The leakage readings D(X) for any particular embodiment depends on the physical configuration of the ambient light sensor and the display screen, as well as on the particular light pattern X.

For a given light pattern X, the detected leakage D is generally the same regardless of the actual surrounding, environmental light level. In other words, D is only a function of X, not of the environmental light. When there is an object in front of the display screen, instead of changing by only D, there is an additional light reflection from the surface of the object, which results in an additional change M(X,P) in the light detected by the ambient light sensor. This amount M is a function of the particular light pattern X as well as the properties (location, orientation, reflective index, etc.) P of the object.

Mathematically, the change in light Δ detected by an ambient light sensor due to (1) the light emitted by the display screen and (2) the light emitted by the display screen that is reflected from an object in the vicinity of the display screen is:

$$Δ = D ( X ) + M ( X , P ) \qquad ( 1 )$$

In other words, when a display screen is not emitting light, then the ambient light sensor detects only environmental ambient light. When the display screen is emitting light and no object is present to reflect light emitted by the display screen to the ambient light sensor, then the ambient light sensor detects both the environmental ambient light and any leakage D. When the display screen is emitting light and an object is present to reflect light emitted by the display screen, then the ambient light sensor detects the environmental ambient light, any leakage D, and reflected light M. In particular embodiments, by analyzing the change in an ambient light sensor's reading, the presence of an object and, in particular embodiments, its interactions with the display screen can be detected, e.g., by estimating P in equation 1.

In particular embodiments, the presence of an object in the vicinity of the display screen may be detected by processing signals output by an ambient light sensor. For example, a median filter may be applied to the time series reading M(X, P) (which is determined by removing the environmental light and leakage detection D(X) from the ambient sensor's detected signal), e.g., to remove random noise from the signal M. An AI model, such as a binary classifier, may be trained on the filtered M values to determine whether an object is present. Training samples may be based on specific objects and/or specific conditions. For example, to determine whether an object is covering the display screen and/or the ambient light sensor, for instance when a sleeve covers a smartwatch worn by a user, training samples M(X,P) may be prepared and used along with ground-truth classification labels (e.g., labels corresponding to “covered” and “not covered”) to train a binary classifier. Once trained, the binary classifier may then be used to classify whether an object is covering the display screen and/or the ambient light sensor. In particular embodiments, if M(X, P) is greater than a threshold, then an object may be classified as covering at least the ambient light sensor. If M(X, P) is less than or equal to the threshold, then an object may be classified as covering at least the ambient light sensor. For instance, in particular embodiments a threshold may be around 30 lux, although other threshold values may be used.

In particular embodiments, whether an object is covering a display screen and/or ambient light sensor may be used to control one or more functionalities of the device. For example, a smartwatch may include built-in health features, such as circadian rhythm estimation and intervention. Adjusting a user's circadian rhythm can be important for boosting health. Ambient light is an important contributor for circadian rhythm, but an ambient light sensor's reading can only be trusted when it is not covered by object, e.g., a sleeve of the user—i.e., if the ambient light reading is negligible, this can be because the ambient light sensor is covered by an object or because the environment is actually dark. Thus, detecting whether an ambient light sensor of a smartwatch is covered can be used to personalize health features such as circadian rhythm estimation and coaching, by accurately detecting when the user is in fact in a dark environment.

In particular embodiments, determining whether an object is present in the vicinity of the display screen includes determining a gesture performed by the object relative to the display screen.

For example, a display screen such as a smartwatch display may emit light at a particular brightness. If an object, such as a user's hand, is in the vicinity of the display screen, then light reflected from the user's hand and detected by the ambient light sensor may be used to detect the presence of the user's hand, based on the determined signal M. In particular embodiments, a distance of the object (e.g., a user's hand) to the display screen may also be determined based on the detected signal M by the ambient light sensor.

In particular embodiments, motion of an object such as a user's hand or fingers, etc. may be detected based the detected signal M over a period of time. For example, if a display screen of an electronic device emits light at a particular level, then M(X,P) will decrease as an object moves away from the electronic device (i.e., away from and in a direction perpendicular to a plane of the display), while M(X,P) will increase as an object moves towards the display screen. Thus, a gesture relative to the display screen may be detected based a change in amplitude of M over time

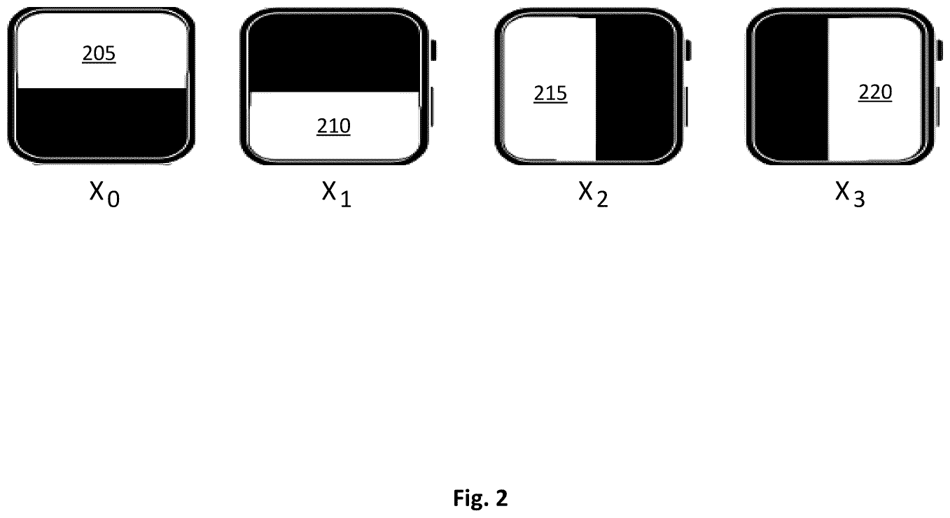

In particular embodiments, the light emitted by a display screen (e.g., in step 110 of the example method of FIG. 1) may include emitting a predetermined pattern of light from the display screen. The predetermined pattern may include a predetermined brightness, a predetermined spatial pattern, or both. For instance, FIG. 2 illustrates example patterns 205, 210, 215, and 220 of light emitted by a display screen, e.g., of a smartwatch. The white portions of each pattern illustrate which portion of the screen is emitting light. For example, in pattern 205 (corresponding to pattern X₀), the upper half of the screen emits light while the lower half does not (or emits much less light).

In particular embodiments, a pattern of emitted light may include a sequence of illuminations. For example, a display screen may iteratively and sequentially emit light corresponding to patterns 205, 210, 215, and 220. After pattern 220 is emitted, then the sequence may repeat with pattern 205. In particular embodiments, each pattern may be emitted for, e.g., ⅕ of a second, and the total emission time may be, e.g., 1-2 totals seconds. In particular embodiment, the emission time for a particular pattern and/or for a sequence of patterns may depend on the sample rate of an ambient light sensor, a refresh rate of a display screen, or both (e.g., whichever rate is lower). For example, if an ambient light sensor has a sample rate of 5 Hz, then the emission times described in the preceding example may be used to accommodate and align with the ambient light sensor's sample rate. As another example, if an ambient light sensor has a sample rate of 30 Hz, and the display screen can refresh at this rate, then each pattern in the example of FIG. 2 may be displayed for approximately 1/30 of a second, and an entire sequence may last for approximately ⅙ to ⅓ of a second or more, depending on how many times the sequence repeats. While the example of FIG. 2 illustrates particular example emission patterns, and a particular sequence of those patterns, this disclosure contemplates that other patterns and sequences may be used.

While a pattern or sequence is emitted, the ambient light sensor detects light received by that sensor. In particular embodiments, different detected signals Mi are assigned to each pattern in a sequence. In other words, the light detected while a particular pattern is emitted is assigned to that pattern, such that each emission pattern has a detection signal associated with it, which is the signal detected when that particular emission pattern (which may iteratively repeat) is emitted by the display.

For example, for a given measurement Mᵢ, the corresponding display-screen emission pattern is Xₖ, where in the example of FIG. 2 k=mod (i, 4). The time series data for each light pattern is extracted, e.g., in FIG. 2 the time series data is {Mᵢₓ₄}, {Mᵢₓ₄₊₁}, {Mᵢₓ₄₊₂}, {Mᵢₓ₄₊₃}. Taking the example of FIG. 2 and an embodiment in which an object is a user's hand moving in a plane parallel to the display screen, then M increases for each emission sequence in FIG. 2 when the hand is approaching the screen and decreases when the hand is moving away from the screen, making it difficult to detect the exact direction of movement of the user's hand. However, differences between the detected signals Mᵢ for each emission pattern in a sequence may be used to determine aspects of an object's movement, such as the direction of movement.

For instance, returning to the example of FIG. 2, when a hand is approaching from the left of the display screen (i.e., the hand is moving right), then the hand reaches the left part of screen earlier than the right part. When the hand is above the left part of the screen, the {Mᵢₓ₄₊₂} data shows a peak value. When the hand moves to the right part of screen, then the {Mᵢₓ₄₊₃} data shows a peak value. In other words, {Mᵢₓ₄₊₃} sees a phase delay compared with {Mᵢₓ₄₊₂}. {Mᵢₓ₄} and {Mᵢₓ₄₊₁}, on the other hand, show a peak value that is temporally between the {Mᵢₓ₄₊₂} and {Mᵢₓ₄₊₃} data.

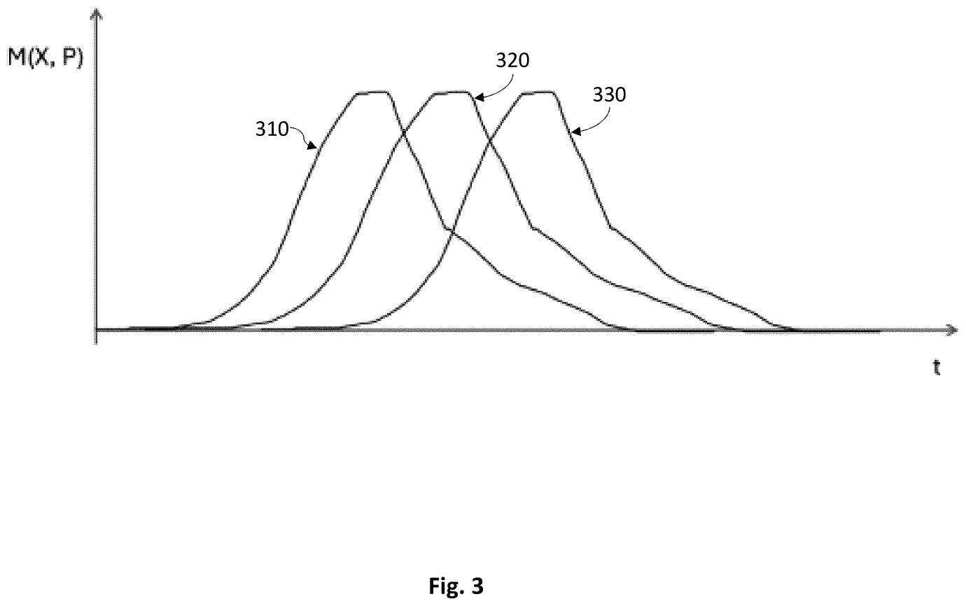

FIG. 3 illustrates an example of the phase delay between the detected Mᵢ signals in an example in which a hand approaches from the left of a display screen emitting the example sequence shown in FIG. 2. FIG. 3 illustrates that, while each Mᵢ has a similar overall signal, certain signals have a relative phase delay. Specifically, detected signal 310 corresponding to {Mᵢₓ₄₊₂} in this example occurs prior to detected signal 320, which corresponds to {Mᵢₓ₄} and {Mᵢₓ₄₊₁} data. Finally, signal 330, which corresponds to {Mᵢₓ₄₊₃} data, occurs after the three other time series M signals.

In particular embodiments, the relative phase delay between Mᵢ signals corresponding to particular emission patterns in a sequence may be used to identify a particular gesture, e.g., the direction of movement of an object (such as a user's hand) relative to a display screen. For instance, the cross correlation between pairs of Mᵢ signals may be used to determine the relative phase delay between detected signals. In particular embodiment, an AI model such as a neural network may be trained to classify a gesture (e.g., the direction of travel, the speed of travel, etc.) based on input relative phase delays particular emission sequence.

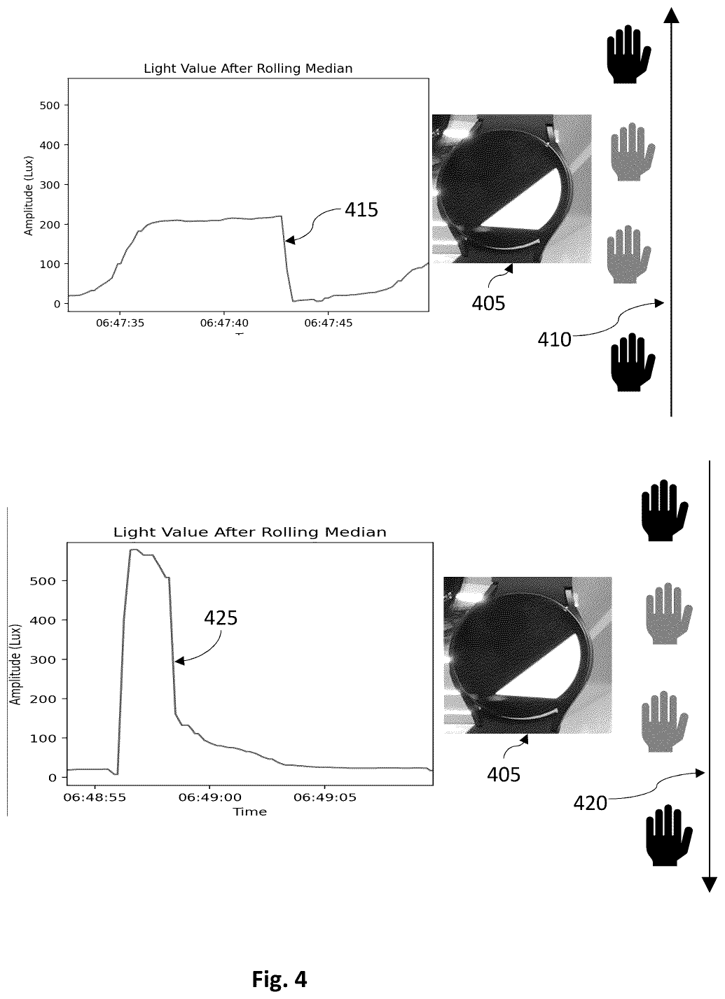

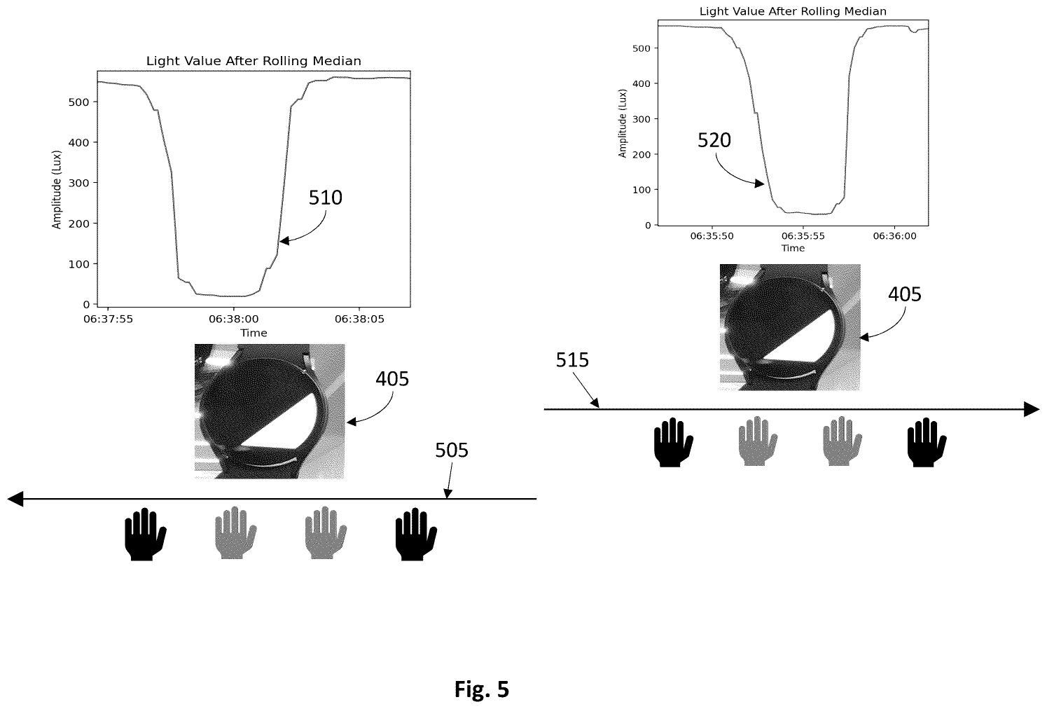

In particular embodiments, rather than emitting a sequence of illumination patterns from the display screen, the display screen may instead use a specific illumination shape to detect an object or gesture. FIG. 4 illustrates an example of gesture detection using a specific illumination pattern 405. In the example of FIG. 4, signal 415 corresponds to the filtered signal M created when a user's hand is above a display screen (in this example, of a smartwatch) and the user moves their hand not in the plane of the display screen, but away from the display screen in a direction 410 perpendicular to the display screen. Likewise, signal 425 corresponds to the filtered signal M created when a user's hand is above the display screen and moves toward the display screen in a direction 420 perpendicular to the display screen. FIG. 5 illustrates two additional examples using the example spatial pattern 405: signal 510 is created when a user moves their hand from right to left (e.g., swipes left) in direction 505 over the display screen in a plane parallel to the plane of the display screen, and signal 520 is created when a user moves their hand from left to right (e.g., swipes right) in direction 515 over the display screen in a plane parallel to the plane of the display screen.

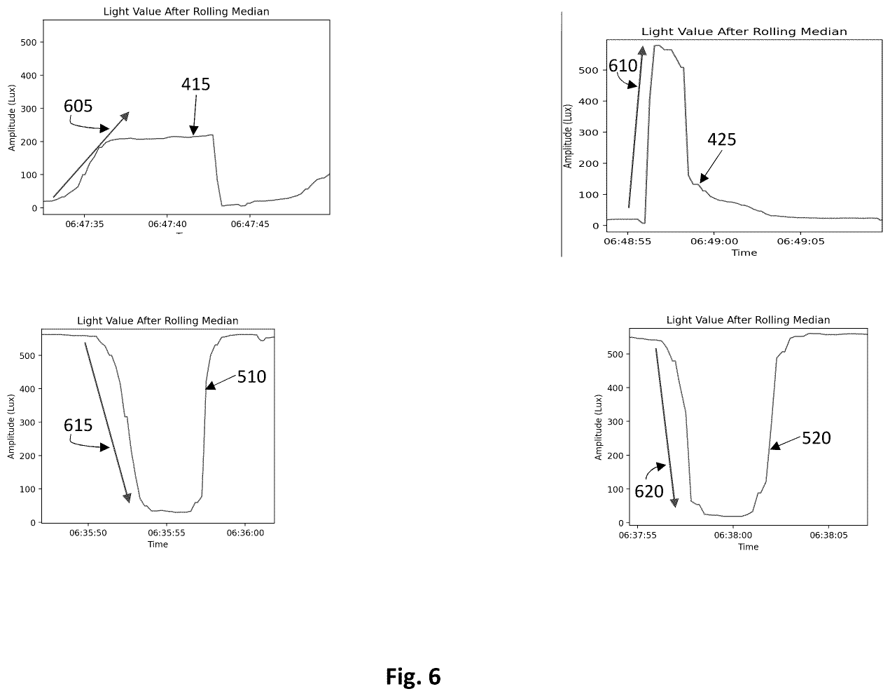

The examples of FIGS. 4-5 illustrate that while a spatially uniform illumination pattern makes it difficult to distinguish between gestures performed by an object, non-spatially-uniform patterns can be used to distinguish among types of gestures. For instance, each detected M signal may be matched to, e.g., a characteristic signal associated with a specific predetermined gesture. The characteristic signal that matches most closely (e.g., as determined by any suitable signal processing technique or by an AI model) to the detected signal may then be used to select the corresponding gesture. As another example, one or more characteristics of a detected signal may be used to determine a specific gesture associated with that signal. For example, FIG. 6 illustrates an embodiment in which the slope of a particular portion of each M signal (represented as amplitude vs. time) is used to identify specific types of gestures. For instance, slope 605 of a portion of signal 415 can be used to distinguish that signal (and therefore, the corresponding gesture) from other signals associated with other gestures.

Likewise, FIG. 6 illustrates how slope 610 of a portion of signal 425, slope 615 of a portion of signal 510, and slope 620 of a portion of signal 520 can be used to associate each detected signal with a specific gesture for a specific emission pattern. Here, for the specific emission pattern 405, the swipe up gesture (corresponding to signal 415) results in a gradually increasing slope, whereas the swipe down gesture (corresponding to signal 425) results in a much steeper increasing slope. Similarly, the swipe right gesture (corresponding to signal 510) results in a gradual downward slope followed by a sharp upward slope, whereas the swipe left gesture (corresponding to signal 520) results in a sharp downward slope followed by a gradual upward slope. In particular embodiments, signal characteristics such as the slope of certain portions of an detected M signal may be input as features to train an AI model to classify a gesture from an input signal M.

Input to electronic devices often occurs through a touch-sensitive display screen on the device. The techniques described above provide an additional input and interaction modality for an electronic device. Using the techniques described above, user interactions can be detected even when the display does not have touch-sensitive capabilities. In addition, even when a device does have touch-sensitive detection capabilities, in circumstances such as when the user's hand is wet, dirty, or occupied with other tasks, touch-sensitive interactions with a touch screen can be difficult or impossible, and the interaction techniques described here can be used to interact with display screen without having to contact the screen. Likewise, certain electronic devices (e.g., smartwatches) have relatively small display screens, and therefore certain kinds of touch-based input (e.g., text input or selecting a particular icon, etc.) is sometimes difficult. Emitting light from a display screen and detecting light received by an ambient light sensor while the display screen is emitting light provides an alternative interaction technique that obviates these challenges, and this interaction technique does not require cameras, IMU sensors, or audio sensors (e.g., microphones).

In particular embodiments, the techniques described herein may be implemented on a relatively large display screen (e.g., a TV having a large screen area). In particular embodiments, when an electronic device's screen size is relatively large, light emission from the display screen using the techniques described herein may be intentionally limited to a portion of the display screen (e.g., a middle portion, a bottom right corner, etc.), and the ambient light sensor may be co-located with or near this portion so that the user can provide interaction input on that specific portion of the display screen.

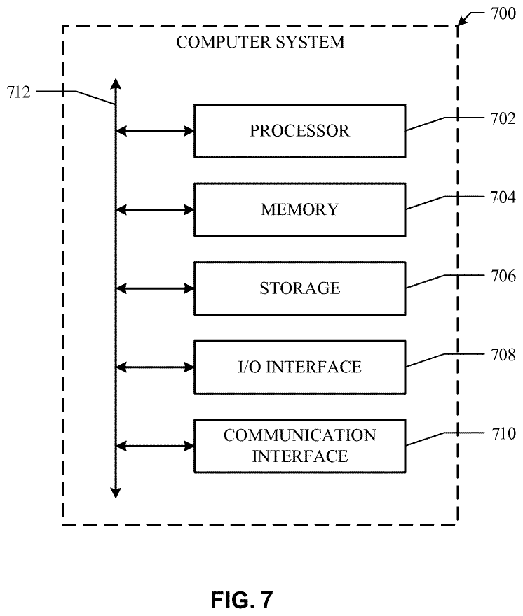

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
emitting light by a display screen of an electronic device;
detecting, by an ambient light sensor, light received by the ambient light sensor while the display screen is emitting light; and
determining, based on the emitted light and on the light detected by the ambient light sensor, whether an object is present in the vicinity of the display screen.

2. The method of claim 1, wherein the electronic device comprises a wrist-worn device.

3. The method of claim 1, wherein determining whether an object is present in the vicinity of the display screen further comprises determining whether an object is covering one or more of the display screen or the ambient light sensor.

4. The method of claim 3, wherein the object comprises an article of clothing worn by a user.

5. The method of claim 4, further comprising determining whether to estimate a circadian rhythm of a user based the determination of whether the object is covering one or more of the display screen or the ambient light sensor.

6. The method of claim 3, further comprising:
filtering a time series of the detected light; and
determining, by a trained classifier, whether the filtered time series is classified as representative of an object covering one or more of the display screen or the ambient light sensor.

7. The method of claim 1, wherein determining whether an object is present in the vicinity of the display screen further comprises determining a gesture performed by the object relative to the display screen.

8. The method of claim 7, further comprising one or more of:
determining that the object is moving towards the display screen in response to a determination that the light detected by the ambient sensor is increasing while the display screen is emitting light; or
determining that the object is moving away from the display screen in response to a determination that the light detected by the ambient sensor is decreasing while the display screen is emitting light.

9. The method of claim 7, wherein emitting light by a display screen of an electronic device comprises emitting a predetermined pattern of light from the display screen.

10. The method of claim 9, wherein the predetermined pattern of light comprises a predetermined sequence of illuminations of the display screen, each illumination in the sequence corresponding to different pattern of illumination on the display screen.

11. The method of claim 10, further comprising:
determining, for each illumination in the sequence, an ambient light signal detected while the display screen is illuminated with that illumination in the sequence;
determining a direction of movement of the object in a plane parallel to a plane of the display screen based on a difference between two or more different ambient light signals, each corresponding to a different illumination in the sequence.

12. The method of claim 11, wherein the difference between the two or more different ambient light signals comprises a phase delay between the two or more different ambient light signals.

13. The method of claim 12, further comprising classifying, by a trained classifier and based on one or more of the phase delays, the movement of the object in the plane parallel to the plane of the display screen.

14. The method of claim 9, wherein the predetermined pattern comprises a predetermined illumination shape.

15. The method of claim 14, further comprising detecting a motion of the object relative to the display screen based on a signal representing an amplitude of the detected ambient light while the predetermined illumination shape is displayed on the display.

16. The method of claim 15, further comprising detecting the motion of the object relative to the display screen based on a slope of the signal representing the amplitude of the detected ambient light.

17. A system comprising:
a display screen of an electronic device;
an ambient light sensor; and
one or more non-transitory computer readable storage media storing instructions; and one or more processors coupled to the one or more non-transitory computer readable storage media and operable to execute the instructions to:
emit light by the display screen;
detect, by the ambient light sensor, light received by the ambient light sensor while the display screen is emitting light; and
determine, based on the emitted light and on the light detected by the ambient light sensor, whether an object is present in the vicinity of the display screen.

18. The system of claim 17, wherein determining whether an object is present in the vicinity of the display screen further comprises determining whether an object is covering one or more of the display screen or the ambient light sensor.

19. The system of claim 17, wherein determining whether an object is present in the vicinity of the display screen further comprises determining a gesture performed by the object relative to the display screen.

20. One or more non-transitory computer readable storage media storing instructions that are operable when executed by one or more processors to:
cause light to be emitted by a display screen of an electronic device;
access a light signal detected by an ambient light sensor while the display screen is emitting light; and
determine, based on the emitted light and on the light signal detected by the ambient light sensor, whether an object is present in the vicinity of the display screen.
